(19) United States
(12) Patent Application Publication
(10) Pub. No.: US 2024/0189820 A1
(43) Pub. Date: Jun. 13, 2024

(54) CELL IMAGING AND COMPRESSION SYSTEM AND METHODS OF USE THEREOF

(71) Applicants: Cellia Science, Inc., Fayetteville, AR (US); Gener8 LLC, San Jose, CA (US); Georgia Tech Research Corporation, Atlanta, GA (US)

(72) Inventors: Francisco E. Robles Guerrero, Atlanta, GA (US); Jiyang Mei, San Diego, CA (US); Kelly Marie Pollock Mabry, Redwood City, CA (US)

(21) Appl. No.: 18/533,935

(22) Filed: Dec. 8, 2023

Related U.S. Application Data
(60) Provisional application No. 63/431,106, filed on Dec. 8, 2022.

(51) Int. Cl. B01L 3/00

(52) U.S. Cl. CPC B01L 3/502761; B01L 3/502715; B01L 2200/025; B01L 2200/0663; B01L 2300/0654; B01L 2300/0816

(57) ABSTRACT

The present invention is directed to systems, methods, and apparatus for an improved microfluidic cell imaging system that allows for the simultaneous application of a compression force to a biological specimen forming a consistent cell monolayer while imaging the cells.

### CROSS-REFERENCES TO RELATED APPLICATION

This application claims the benefit of and priority to U.S. Provisional Application No. 63/431,106, filed Dec. 8, 2022. The entire specification and figures of the above-referenced application is hereby incorporated in its entirety by reference.

### STATEMENT OF GOVERNMENT INTEREST

This invention was made with Government support under grant numbers R35GM147437 and R43HL167435 awarded by the National Institutes of Health (NIH), and grant number 1752011 awarded by the National Science Foundation (NSF). The U.S. Government has certain rights in this invention.

### TECHNICAL FIELD

The present invention is directed to the field of microfluidics and in particular microfluidic devices for imaging live cells while under a compression force generating a cell monolayer.

### BACKGROUND

Common microfluidic devices, such as hematology analyzers typically use a combination of techniques, such as spectroscopy, impedance measurements, and flow cytometry, to characterize blood cell counts. The gold standard for blood cell analysis (required when there are irregular results) remains the microscopic analysis of peripheral blood smears. Currently, blood smears must be performed by a trained technician and can suffer from quality issues due to the manual nature of the technique. However, currently available hematology analyzers are capable of rapid staining and automated analysis, they are costly and require multiple chemical reagents and regular calibration and maintenance. Thus, despite being one of the most common medical tests, complete blood count (CBC) has to be performed by highly trained technicians at clinics or commercial laboratories that have the necessary equipment and infrastructure in place, which has the adverse effect of delaying critical (in some cases, life-saving) health information. Moreover, for pathological samples or samples that produce atypical results, manual microscopic examination is often required to confirm CBC findings and to evaluate the morphology of blood cells. A number of methods have been explored to facilitate and improve hematological analysis, mostly aimed at developing point-of-care CBC devices.

In one advancement, researchers have demonstrated the ability to use microfluidic devices to prepare the blood cell monolayer. To achieve a cell monolayer without overlapping cells and cell morphology consistent with that observed in a blood smear, a weight was applied to the device after loading the blood sample. This technique was used to obtain neutrophil counts consistent with those from a commercial hematology analyzer. However, this system was limited in several important aspects. For example, the compression and imaging must be performed as separate and distinct steps, increasing wait-times, while decreasing the system's accuracy and ability to product consistent diagnostic results. As a result, the above system has limited viability as a simple, and efficient point-of-care device.

As such, the current invention addresses this long felt need for a simple and accurate microfluidic device that efficiently incorporates the simultaneous application of a compression force to form a consistent cell monolayer while imaging. This approach as described below decreases the time required to analyze a sample and mitigates red blood cell instability that have been observed using the previous technique. The present invention described herein enables point-of-care cell imaging, and in particular hematology analysis, by minimally trained operators, reducing barriers to testing and providing faster results, and therefore faster access to treatment.

### SUMMARY OF THE INVENTION

This present invention is accomplished through the use of a microfluidic device, which can be compressed by a fixture containing a LED light source. An injection molded bracket top to the device provides additional support, but contains a window for the application of force and transmission of light. This approach is particularly useful for imaging via deep-ultraviolet (deep-UV) microscopy of blood cells in passive microfluidic devices.

The present invention includes a novel cell imaging system. In this preferred example, the cell imaging system of the invention includes a microfluidic device adapted to hold a biological sample within an active area of a compressible substrate. A compression assembly can be configured to apply a compression force to the compressible substrate forming a cell monolayer within the active area. A light source, which can be part of the compression assembly in certain embodiments, can be directed to the active area to allow observation of the cell monolayer by an imaging instrument. In this configuration, the cell imaging system allows an imaging device, such as a microscope or camera, to image and/or observe the cell monolayer within the active area while a compression force is applied to said compressible substrate.

The present invention further includes a cell imaging device. In this preferred example, the cell imaging device of the invention includes a microfluidic device adapted to hold a biological sample within an active area of a compressible substrate. A pressure actuated compression assembly is configured to apply a compression force to the compressible substrate forming a cell monolayer within the active area, such that an imaging device can image and/or observe the cell monolayer within the active area while a compression force is applied to the compressible substrate.

The present invention further includes a cell imaging compression system. In this preferred example, the cell imaging compression system includes a microfluidic device having a housing adapted to hold a biological sample within an active area of a compressible substrate. The compression assembly is configured to be coupled with the housing to apply a compression force to the compressible substrate forming a cell monolayer within said active area, and optionally allow an imaging device to image and/or observe the cell monolayer within the active area while the compression force is applied to said compressible substrate.

The present invention further includes methods of quantifying the volume of a sample, such as a blood or other biological sample, based on the volume of sample distributed per area which is correlated with the compression force applied to the sample via the device of the invention.

Additional aspects of the invention may be evidenced from the specification, claims, and figures provided below.

### BRIEF DESCRIPTION OF THE FIGURES

FIG. 1. shows a front perspective view of an exemplary cell imaging system having a microfluidic device adapted to hold a biological sample within an active area of a compressible substrate responsive to a compression assembly configured to apply a compression force to the compressible substrate forming a cell monolayer within the active area in one embodiment thereof;

FIG. 2. shows a front perspective view of an exemplary cell imaging system positioned adjacent to an exemplary microscope, having a microfluidic device adapted to hold a biological sample within an active area of a compressible substrate responsive to a compression assembly configured to apply a compression force to the compressible substrate forming a cell monolayer within the active area in one embodiment thereof;

FIG. 3. shows an exploded view of a compressible substrate formed by a base plate and channel plate further forming a microfluidic channel configured to be secured in a housing in one embodiment thereof;

FIG. 4. shows a microfluidic device having a compressible substrate formed by a base plate and channel plate further forming a microfluidic channel secured in a housing having an input and output position in fluid communication with the microfluidic channel in one embodiment thereof;

FIG. 5. shows a microfluidic device having a compressible substrate formed by a base plate and channel plate further forming a microfluidic channel secured in a housing and adapted to be secured in a recess of an imaging platform in one embodiment thereof;

FIGS. 6A-B. (A) shows an isolated view of a compression assembly having a plurality of calibrated springs securing a top compression panel and a bottom compression panel in one embodiment thereof; (B) shows a cross section view of a compression assembly having a cylinder positioned within a calibrated spring and movable secured by an upper and lower support post in one embodiment thereof;

FIG. 7. shows a cross-section view of a microfluidic device coupled with a compression cell and guide adaptor of a compression assembly having an internally positioned light source positioned along the light pathway of an imaging device in one embodiment thereof;

FIG. 8. shows a cross-section of a force diagram of an exemplary compression assembly having a plurality of calibrated springs securing a top compression panel and a bottom compression panel in one embodiment thereof;

FIG. 9. shows and exploded view of a cell imaging device having a microfluidic device adapted to hold a biological sample within an active area of a compressible substrate responsive to a pressure actuated compression assembly configured to apply a compression force to the compressible substrate forming a cell monolayer within the active area in one embodiment thereof;

FIG. 10. shows a cell imaging device having a microfluidic device adapted to hold a biological sample within an active area of a compressible substrate responsive to a pressure actuated compression assembly in fluid communication with an air slot positioned on the bottom surface of the channel plate through a pressure conduit configured to apply an upward compression force to the compressible substrate forming a cell monolayer within the active area in one embodiment thereof;

FIG. 11. shows a housing of a microfluidic device adapted to hold a biological sample within an active area of a compressible substrate responsive to a pressure actuated compression assembly in one embodiment thereof;

FIG. 12. shows an exploded view of a housing of a microfluidic device adapted to hold a biological sample within an active area of a compressible substrate responsive to a pressure actuated compression assembly in fluid communication with an air slot positioned on the bottom surface of the channel plate through a pressure conduit configured to apply an upward compression force to the compressible substrate forming a cell monolayer within the active area in one embodiment thereof;

FIG. 13. shows a housing of a microfluidic device adapted to hold a biological sample within an active area of a compressible substrate responsive to a pressure actuated compression assembly positioned adjacent to an imaging device and further aligned along a UV light pathway in one embodiment thereof;

FIG. 14. shows an exploded view of a shows a housing of a microfluidic device adapted to hold a biological sample within an active area of a compressible substrate responsive to a compression assembly configured to be coupled with an upper portion of the housing and apply a compression force to the compressible substrate forming a cell monolayer within said active area in one embodiment thereof;

FIG. 15. shows an assembled housing of a microfluidic device adapted to hold a biological sample within an active area of a compressible substrate responsive to a compression assembly configured to be coupled with an upper portion of the housing and apply a compression force to the compressible substrate forming a cell monolayer within said active area in one embodiment thereof;

FIG. 16. shows an isolated spring-actuated compression assembly having a pair of guides configured to be coupled with corresponding rails on the upper portion of the housing and apply a compression force to the compressible substrate forming a cell monolayer within said active area in one embodiment thereof;

FIG. 17. shows a spring-actuated compression assembly having a pair of guides being coupled with corresponding rails on the upper portion of the housing in one embodiment thereof;

FIG. 18. shows an isolated spring-actuated compression assembly having a pair of guides configured to be coupled with corresponding rails at the approximate midpoint on the upper portion of the housing and secured by an extension secured with a catch and apply a compression force to the compressible substrate forming a cell monolayer within said active area in one embodiment thereof;

FIG. 19. shows a spring-actuated compression assembly having a pair of guides being coupled with corresponding rails on the upper portion of the housing in one embodiment thereof; and

FIG. 20. shows a cross-section view of a spring-actuated compression assembly having a pair of guides configured to be coupled with corresponding rails at the approximate midpoint on the upper portion of the housing and secured by an extension secured with a catch and apply a compression force to the compressible substrate forming a cell monolayer within said active area in one embodiment thereof;

FIG. 21. shows a force diagram of an exemplary spring-actuated compression assembly in one embodiment thereof; and

FIG. 22. shows a microfluidic device having a compressible substrate formed by an adhesive membrane sandwiched between a channel plate and base plate and secured in a housing in one embodiment thereof.

### DETAILED DESCRIPTION OF THE INVENTION

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are now described.

The present invention is directed to systems, methods, and apparatus for an improved microfluidic cell imaging system that allows for the simultaneous application of a compression force to a biological specimen, such as a blood sample forming a consistent cell monolayer while imaging through, for example deep-UV microscopy. In addition to creating a monolayer such that that sample cells are non-overlapping, the present invention also applies a compression force to a biological specimen to recapitulate the appearance of cells in, for example a blood smear and thereby enabling the identification of red blood cells (RBCs), platelets, and white-blood cells (WBCs) and performing a 5-part WBC differential.

In one preferred aspect, the present invention includes a cell imaging system comprising a microfluidic device (3) adapted to hold a biological sample within the active area (14) of a compressible substrate (32). The microfluidic device (3) may be coupled with a compression assembly (25) configured to generate compression force on the compressible substrate (32) forming a cell monolayer at an active area formed by the compressible substrate (32). Imaging of the cell monolayer generated by the compression force can be aided by a light source (22) directed to an active area (14) being positioned along a light pathway (24) adapted to be in-line with an imaging device (1), such as a microscope, or camera. As noted above, in this embodiment, cell imaging system is configured to allow imaging or direct observation of the cell monolayer within the active area (14) while a compression force is applied to said compressible substrate (32).

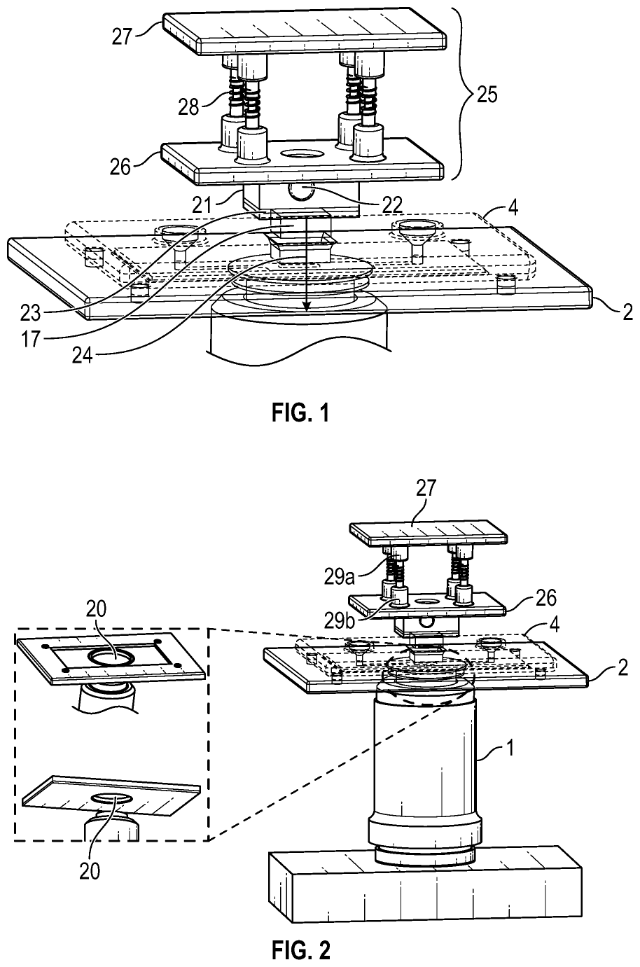

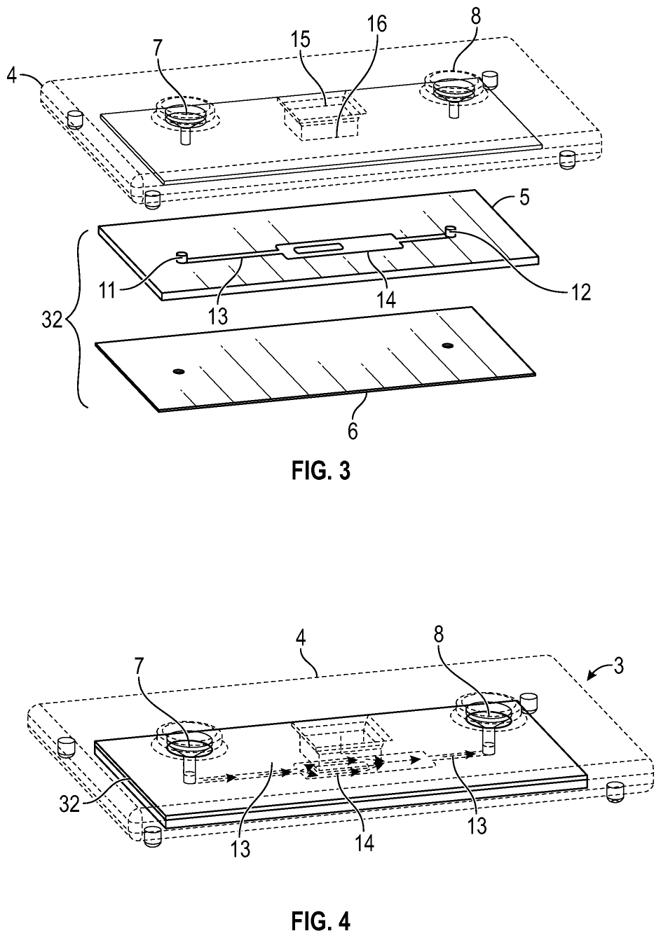

The cell imaging system of the invention may include a compressible substrate (32) formed by a channel plate (5) and a base plate (6). As shown in FIG. 3, in a preferred embodiment, the channel plate (5) and base plate (6) may be formed, at least in part from a compressible material, such a silicone or other material known in the art. The channel plate (5) of the invention may include a microfluidic channel (13) having an active area (14) configured to receive a biological specimen, preferably a blood specimen from a subject containing one or more live cells. The base plate (6) of the invention may be configured to be positioned adjacent to the channel plate (5) forming a compressible substrate (32) that can be secured by a housing (4), formed preferably from a substantially non-compressible material. As further detailed below, a load force applied to the compressible substrate (32) causes the compression of the channel and base plates (5,6) together causing the live cells of the biological sample within the active area (14) to diffuse thereby forming a cell monolayer. As shown in FIGS. 1-2, the active area (14) containing the cell monolayer can be positioned along the light pathway (24) of an imaging device (1), and preferably along a UV light pathway (24) of a microscope, camera or other imaging device known the art, and directly observed by a user. The housing of the invention (4) may further be secured to an imaging device (1).

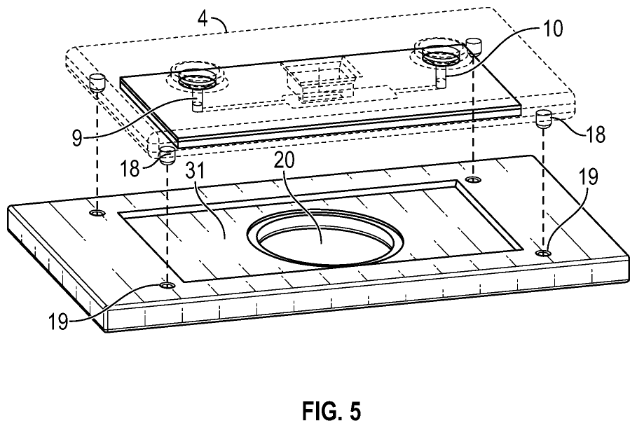

As further shown in FIG. 5, the housing may be coupled to the platform (2) of an imaging device (1) through one or more extensions (18) configured to be secured by one or more alignment slots (19) on the platform. As further shown in FIG. 5, in an alternative embodiment, the compression substrate (32) of the invention may be positioned within a recess (31) formed by an integral depression in the platform of an imaging device (1). In this configuration, the microfluidic device (3) can be aligned along a light pathway (24) such that a light source (22) is aligned with the active area (14) and imaging aperture (20) to allow direct imaging and observation of the compression-generated cell monolayer.

The cell imaging system of the invention may include a housing (4) in fluid communication with a microfluidic channel (13) positioned in the compressible substrate (32) through one or more input positions (7) and outlet positions (8) forming an open-loop microfluid circuit to facilitate the capillary flow of a biological sample across the active area (14) of the invention. As shown in FIG. 3, in a preferred embodiment, the housing (4) of the invention includes an input position (7) and outlet position (8) positioned on the top surface of the housing (4) such that a biological sample, such as a blood sample containing live cells can be inserted into an input position (7) and transmitted to a microfluidic channel (13) through an input channel (9) in fluid communication with an input receiver (11). The microfluidic channel (13) of the invention may preferably be configured to include a hydrophilic inner surface to facilitate the capillary flow of the liquid sample through the channel (13). In one embodiment, a hydrophilic inner surface can be created through plasma treatment, incorporation of hydrophilic components into the based composition, such as the bulk silicone, or application of a coating to the channel surfaces forming a hydrophilic layer.

The microfluidic channel (13) of the invention may include an active area (14) positioned approximately centrally in the compression substrate (32), and may be characterized with a plurality of separable channels to route the capillary flow of the liquid sample, such that a load force applied allow the expansion of sample so as to form a cell monolayer in a fixed position within the active are (14). As further shown in FIG. 2, the microfluidic channel (13) of the invention is in fluid communication with an outlet position (8) through an outlet receiver (12) and outlet channel (10). In this configuration the biological sample, and preferably a liquid blood sample containing one or more live cells, can be directed microfluidic channel (13) and across the active area (14) by the capillary flow of the channel (13) toward the outlet position (8).

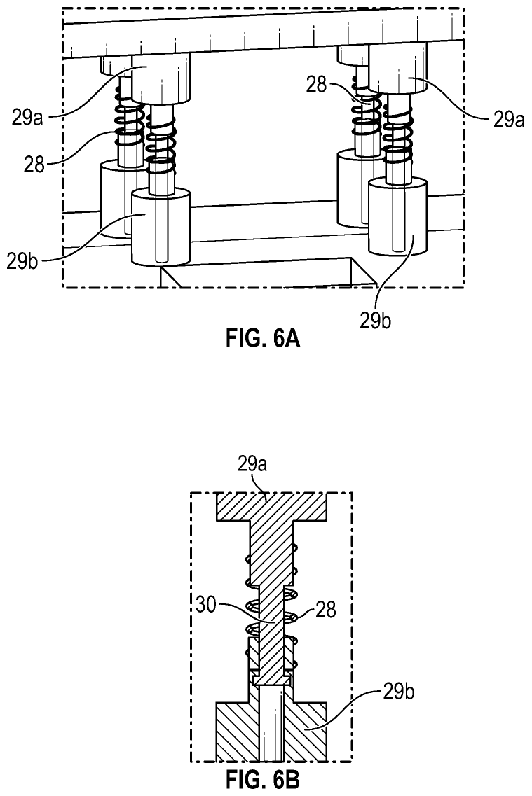

Referring now to FIGS. 1-2, the cell imaging system of the invention includes a compression assembly (25). In this preferred embodiment, the compression assembly (25) can include a spring-actuated compression assembly (25) having bottom compression panel (26) and a top compression panel (27) coupled by one or more calibrated springs (28). As further shown in FIG. 6, the calibrated springs (28) of the invention may be secured to upper support post (29a) and lower support post (29b) which provide an anchor point, as well as position the calibrated springs (28) so as to provide a substantially uniform downward load for onto the compressible substrate (32) as detailed below.

In the embodiment shown in FIG. 6B, a cylinder (30) may be positioned over the calibrated spring (28) and movable secured by the bottom compression panel (26) and a top compression panel (27), preferably through the upper and lower support posts, respectively (29a, 29b). In this configuration, the cylinder of the invention provides additional support and alignment for the calibrated spring (28) and allow for the direction control of the load force applied and transmitted through the compression assembly (25). As further shown in FIG. 8, the load force (N) applied to the compressible substrate (32) can be determined by the force generated and transmitted through the calibrated springs (28) (i.e., F_{spring}=4kx) such that application of a force to, for example a top compression panel (27) can adjust the value of x calibrating the force applied to compressible substrate (32). As further shown in FIG. 21, the load force (N) applied to the compressible substrate (32) can be adjusted by establishing the relationship between the compression distance (d), which can be dependent on the hardness, or compressibility of the material, which in a preferred embodiment comprises a silicone material.

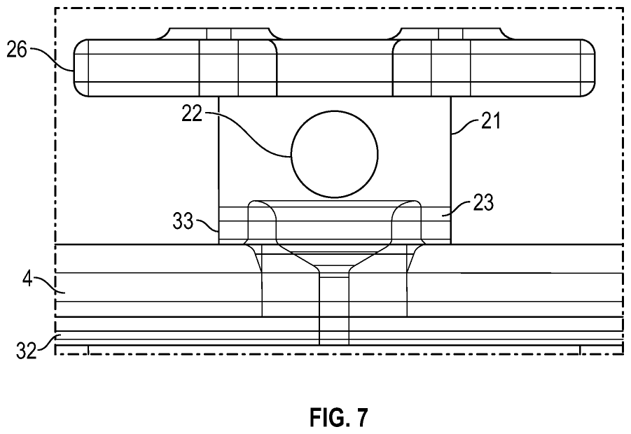

Referring again to FIGS. 1-2, the cell imaging system of the invention includes a compression assembly (25) having a compression cell (21) configured to be positioned adjacent to the compressible substrate (32) and transmit the load force from the assembly. In a preferred embodiment, the compression cell (21) of the invention may include a guide adaptor (17) configured to be positioned along the light pathway (24) and transmit the load force from the compression assembly (25) to the active area (14) or the compressible substrate (32). In the preferred embodiment shown in FIG. 7, the guide adaptor (17) of the invention can be inserted into a compression slot (15) having a viewing surface (16) on the top surface of the housing (4), such that the load force generated by the compression assembly (25) is transmitted through the compression cell (21) to the guide adaptor (17) where it is applied to the compression substrate (32) causing the active area to be compressed and form a cell monolayer as described generally herein. As shown in the FIG. 1, the guide adaptor (17) and viewing surface (16) of the invention can be positioned within the light pathway (24) and further be formed of a translucent material to allow transmission of a light source (22) as described below. As shown in FIG. 7, in one preferred embodiment, the compression cell (21) of the invention may include an overhang surface (33) configured to be positioned against the top surface of the housing (4) which may provide a mechanical stop position to prevent excess load force being applied to the compressible substrate (32). Notably, the guide adaptor (17) and compression cell may be a separable, or integral components as shown herein.

The cell imaging system of the invention includes a compression assembly (25) having a light source (22). As further shown in FIGS. 1-2, and 7, a light source (22), such as a UV light source can be positioned within the compression cell (21) and further positioned within the light pathway (24). An optical diffuser (23) can further be positioned within the light pathway, between the light source and the imaging device (1). In this preferred embodiment, the light source (22) of the invention generates a directed quantity of light, and preferably UV light that is positioned along the light pathway (24). This light passes through an optical diffuser (23), and in this embodiment a translucent guide adaptor (17) and viewing surface, so as to be directed to the active area (14) of the invention. Notably, a load force provided by the compression assembly (25) described above can be concurrently applied to the active area (14) fixing a cell monolayer for observation.

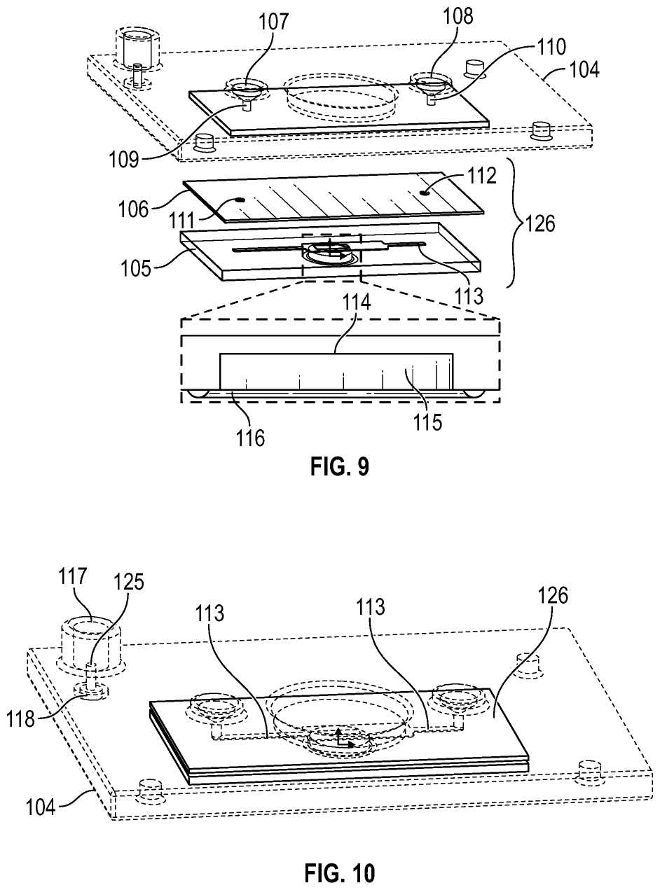

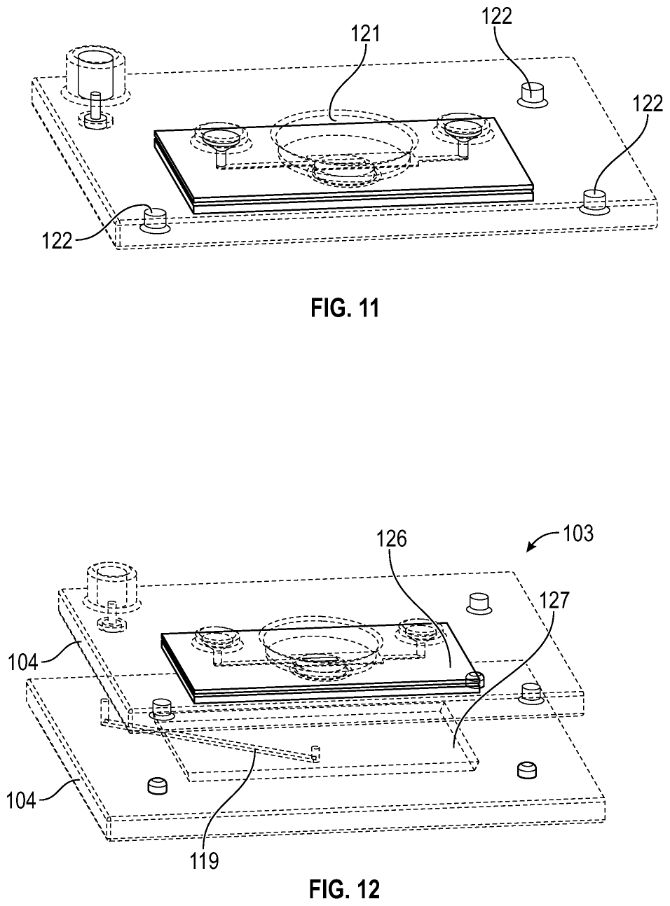

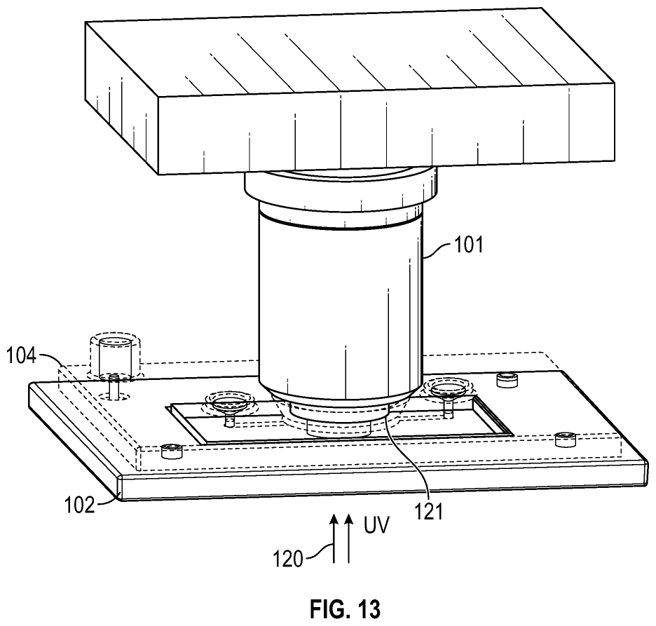

As shown in FIGS. 9-13, the invention includes a cell imaging device having a pressure actuated microfluidic device (103) adapted to hold a biological sample within an active area (114) of a compressible substrate (126). In a preferred embodiment, the device of the invention includes a pressure actuated compression assembly configured to simultaneously apply a compression force to the compressible substrate (126) forming a cell monolayer within the active area while the sample is being observed by an imaging device (101).

In the preferred embodiment shown in FIG. 9, the compressible substrate (126) of the ______ is formed by a channel plate (105) and a base plate (106). As shown in FIG. 9, in a preferred embodiment, the channel plate (105) and base plate (106) may be formed, at least in part from a compressible material, such a silicone or other material known in the art. The channel plate (105) of the invention may include a microfluidic channel (113) having an active area (114) configured to receive a biological specimen, preferably a blood specimen from a subject containing one or more live cells. The base plate (106) of the invention may be configured to be positioned adjacent to the channel plate (105) forming a compressible substrate (126) that can be secured by a housing (104), formed preferably from a substantially non-compressible material. As further detailed below, a pressure actuated compression assembly can generate a load force which is applied to the compressible substrate (32) causes the compression of the channel and base plates (105, 106) causing the live cells of the biological sample within the active area (14) to diffuse thereby forming a cell monolayer. As shown in FIGS. 1-2, the active area (114) containing the cell monolayer can be positioned along the light pathway (120) of an imaging device (1), and preferably along a UV light pathway (120) of a microscope, camera or other imaging device known the art, and directly observed by a user. The housing of the invention (4) may further be secured to an imaging device (1), and preferably to the platform of an imaging device (101) through one or more extension (122) and alignment slot (123) coupling positions.

The cell imaging system of the invention may include a housing (104) in fluid communication with a microfluidic channel (113) positioned in the compressible substrate (126) through one or more input positions (107) and outlet positions (108) forming an open-loop microfluid circuit to facilitate the capillary flow of a biological sample across the active area (114) of the invention. As shown in FIG. 9, in a preferred embodiment, the housing (104) of the invention includes an input position (107) and outlet position (108) positioned on the top surface of the housing (104) such that a biological sample, such as a blood sample containing live cells can be inserted into an input position and transmitted to a microfluidic channel (113) through an input channel (counting live cells can 9) in fluid communication with an input receiver (111). The microfluidic channel (113) of the invention may preferably be configured to include a hydrophilic inner surface to facilitate the capillary flow of the liquid sample through the channel (113).

The microfluidic channel (113) of the invention may include an active area (114) positioned approximately centrally in the compression substrate (126), and may be characterized with a plurality of separable channels to route the capillary flow of the liquid sample, such that a load force applied allow the expansion of sample so as to form a cell monolayer in a fixed position within the active are (114). As further shown in FIG. 9, the microfluidic channel (113) of the invention is in fluid communication with an outlet position counting live cells can (8) through an outlet receiver (112) and outlet channel (10). In this configuration the biological sample, and preferably a liquid blood sample containing one or more live cells, can be directed microfluidic channel (113) and across the active area (114) by the capillary flow of the channel (113) toward the outlet position (108).

The pressure actuated microfluidic device (103) of the invention may include a housing (4) securing an actuator (117) in fluid communication with a pressure conduit (119). As shown in FIGS. 9-12, a pressurized air generated from an air pump (125) can be transmitted through actuator, which may further include a valve (118) component, to allow regulation of the air flow. Pressurized air passes through the actuator (117) of the invention and through a pressure conduit (119) that is in fluid communication with an air slot (115). As shown in FIG. 9, the air slot (115) of the invention can include an integral slot position on the bottom of the compressible substrate (126). In this configuration, compressed air enters the air slot generating an upward force causing compression of the channel and base plates (105, 106) of the compressible substrate (126) positioned preferably in a recess (127) of the housing, forming a cell monolater within the corresponding active area (114) that may further be positioned adjacent to an imaging slot (121) that itself is configured to be positioned along the light pathway (12) to allow observation of the active area (114)

As further shown in FIG. 9, a seal (116) maybe positioned adjacent to the air slot (115) to ensure that—the upward compression force is maintained and the channel plate (105) transits upward in response generated by the pressure differential within the air a lot (115). It should be noted that the position and number of the air slots (115) can be variable, and indeed can be configured to apply a downward force on the compressible substrate (126) in certain alternative embodiments.

The present invention further includes cell imaging compression device that can include a microfluidic device (201) having a housing comprising an upper housing (202) and lower housing adapted to hold a biological sample within an active area (205) of a compressible substrate (204), the housing being configured to be coupled with a compression assembly (216) configured to be coupled with the housing (201, 202) and apply a compression force to the compressible substrate (204) forming a cell monolayer within said active area (114). In a preferred embodiment, the device of the invention is configured to allow an imaging device to image and/or observe the cell monolayer within the active area (114) while said compression force is applied to the compressible substrate 204).

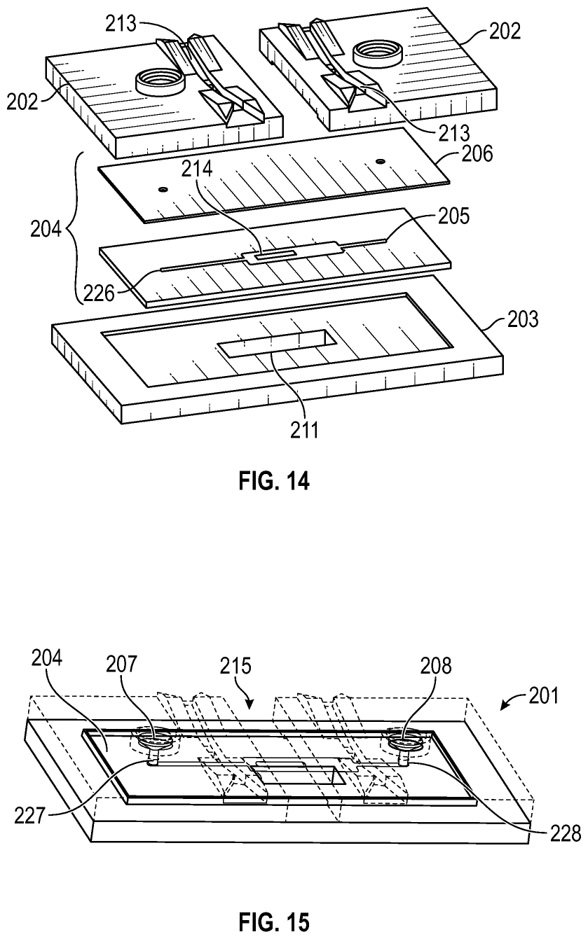

In the preferred embodiment shown in FIG. 14, the compressible substrate (204) of the is formed by a channel plate (205) and a base plate (206). In a preferred embodiment, the channel plate (205) and base plate (206) may be formed, at least in part from a compressible material, such a silicone or other material known in the art. The channel plate (205) of the invention may include a microfluidic channel (226) having an active area (225) configured to receive a biological specimen, preferably a blood specimen from a subject containing one or more live cells. The base plate (206) of the invention may be configured to be positioned adjacent to the channel plate (205) forming a compressible substrate (204) that can be secured by a housing, which may include an upper and lower portion (202, 203), formed preferably from a substantially non-compressible material. As further detailed below, a compression assembly can generate a load force which is applied to the compressible substrate (204) causes the compression of the channel and base plates (202, 203) causing the live cells of the biological sample within the active area (225) to diffuse thereby forming a cell monolayer. The active area (225) containing the cell monolayer can be positioned along the light pathway (not shown) of an imaging device (not shown), and preferably along a UV light pathway (120) of a microscope, camera or other imaging device known the art, and directly observed by a user. The housing of the invention may further include a viewing aperture (212) configured to be positioned along a light pathway (not showing) to allow imaging of the active area (225).

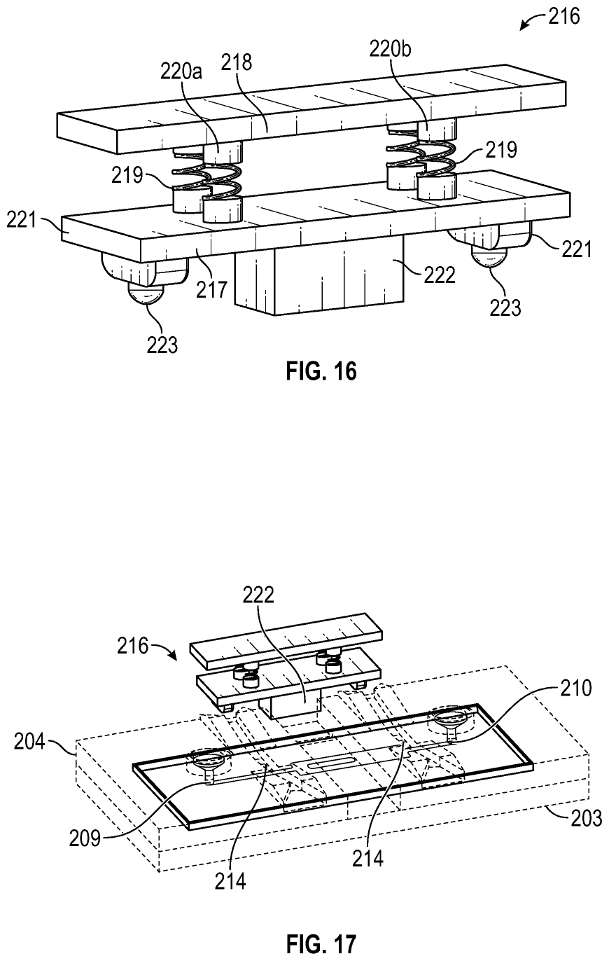

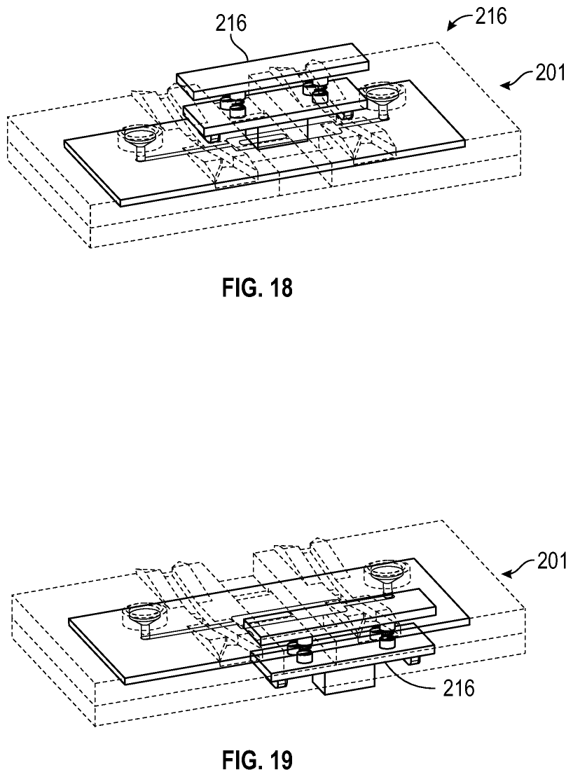

The cell imaging system of the invention may include a housing, and preferably an upper housing (202) in fluid communication with a microfluidic channel (226) positioned in the compressible substrate (204) through one or more input positions (207) and outlet positions (208) forming an open-loop microfluid circuit to facilitate the capillary flow of a biological sample across the active area (225) of the invention. As shown in FIGS. 16-19, in a preferred embodiment, the upper housing (20) of the invention, which may be separable or integral with the lower housing (203), includes an input position (207) and outlet position (208) positioned on the top surface of the upper housing (202) such that a biological sample, such as a blood sample containing live cells can be inserted into an input position and transmitted to a microfluidic channel (226) through a an input channel (227) in fluid communication with an input receiver (209). The microfluidic channel (226) of the invention may preferably be configured to include a hydrophilic inner surface to facilitate the capillary flow of the liquid sample through the channel (226).

The microfluidic channel (226) of the invention may include an active area (225) positioned approximately centrally in the compression substrate (204), and may be characterized with a plurality of separable channels to route the capillary flow of the liquid sample, such that a load force applied allow the expansion of sample so as to form a cell monolayer in a fixed position within the active are (225). As further shown in FIG. 15, the microfluidic channel (226) of the invention is in fluid communication with an outlet position (208) through an outlet receiver (210) and outlet channel (228). In this configuration the biological sample, and preferably a liquid blood sample containing one or more live cells, can be directed microfluidic channel (226) and across the active area (225) by the capillary flow of the channel (226) toward the outlet position (208).

The actuated microfluidic device (201) of the invention may include a housing configured to secure a mountable compression assembly (215). As shown in FIG. 14, the upper housing (202) may include one or more rails (213) that are adapted to receive a corresponding guide (221) positioned on the underside of the bottom compression panel (217) of a compression assembly (215). In a preferred embodiment, the upper housing (202) includes a pair rails (213) positioned laterally to a gap forming a compression channel (215). In this configuration, the guides (221) positioned on the underside of the bottom compression panel (217) can be slidably coupled to the upper housing (202) thereby positioning the compression assembly (215) approximately over the microfluidic channel (226), and in particular the active area (225).

As shown in FIGS. 17-19, a compression cell (222) coupled to the bottom compression panel (217) of the compression assembly (216) can be slidably positioned within a compression channel (215) such that the cell is positioned approximately over the microfluidic channel (226), and in particular the active area (225). The compression assembly (216) can be secured in this central position by engagement of one or more coupler positions, which in a preferred embodiment include one or more extensions (223) positioned on the underside of on each guide (221) that can be coupled to a corresponding catch (214) positioned along the rail (213) of the invention.

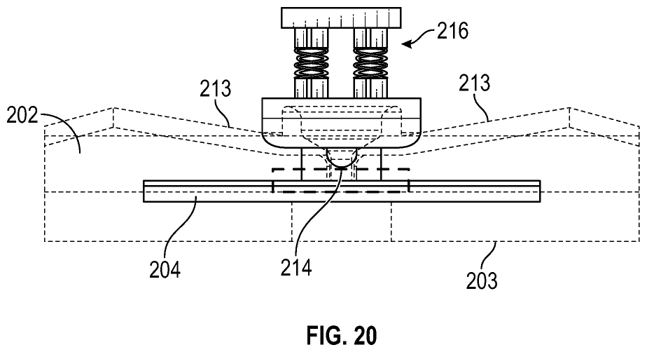

Referring now to FIGS. 17 and 20, the compression assembly (216) can include a bottom compression panel (217) and a top compression panel (218) coupled by one or more calibrated springs (219). As described above, the calibrated springs (219) of the invention may be secured to the upper support post (220a) and lower support post (220b) which provide an anchor point, as well as position the calibrated springs (219) so as to provide a substantially uniform downward load for onto the compressible substrate (204) as detailed below. In a preferred embodiment, this downward load force can be transmitted to the compressible substrate (204) through a compression cell (222) positioned within the compression channel (215). Again, as described above, the load force (N) applied to the compressible substrate (204) can be determined by the force generated and transmitted through the calibrated springs (219) (i.e., F_{spring}=4kx) such that application of a force to, for example a top compression panel (216) can adjust the value of x calibrating the force applied to compressible substrate (204). In another embodiment, as described herein, the compression assembly (216) may include a light source (not shown) that may be positioned along a light pathway to allow simultaneous application of a compression force to the active are forming a cell monolayer while operating an imaging device (not shown) to observe or record the cells of the monolayer.

Notably, in one preferred embodiment, the amount of compression applied to generate the cell monolayer can be adjusted to produce a desired cell orientation and/or morphology. In one example, the compression force can be adjusted such that the monolayer recreated the appearance of a cell in a blood smear or to make features within the cell, such as the nucleus or granules, more visible.

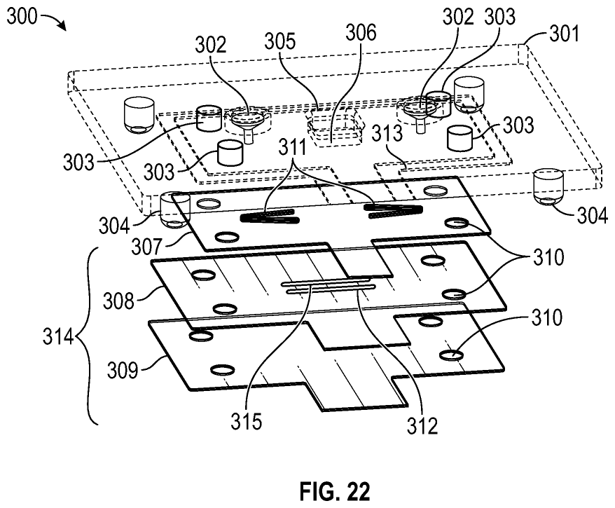

Referring now to FIG. 22, in one embodiment the microfluidic device (300) housing configured to secure a compressible substrate (314) having an adhesive membrane (308) positioned between a channel plate (307) and a base plate (309). Referring to the preferred embodiment in FIG. 22, the housing (301) of the invention can be formed of a plastic or other rigid material and further include one or more extensions (304) configured to mate with a slot on base support (not shown) and ensure proper alignment of the device (300) with respect to a light pathway and/or microscope field of view. The housing (301) of the invention can further include one, or in a preferred embodiment a plurality of input positions (302) that is adapted to receive a biological sample, preferably containing live cells, such as a blood or other biological fluid.

Again, as shown in the preferred embodiment of FIG. 22, the housing (301) of the invention includes a compression slot (305) having a viewing surface (306) on the top surface of the housing (4), which, as described above is configured such that the load force generated by a compression assembly is transmitted to the compression substrate (304) causing the active area to be compressed and form a cell monolayer as described generally herein. As also noted above, the viewing surface (306) of the invention can be positioned within the light pathway (24) and further be formed of a translucent material to allow transmission of a light source (22) as described herein.

The housing (301) of the invention includes a channel (313) preferably positioned on the bottom of the body of the housing (301) and configured to secure a compressible substrate (314) assembly. In a preferred embodiment, the channel (313) includes one or more extensions (304) that can be mated with corresponding alignment slots (310) on the sub-components of the compressible substrate (314) assembly.

Referring again to FIG. 22, the compressible substrate (314) assembly of the invention includes a plurality of sandwiched membranes. In a preferred embodiment, an adhesive membrane (308) is sandwiched between a channel plate (307) and a base plate (309). In still further embodiment, the channel plate (307) can be formed from a silicone material, and preferably a liquid silicone rubber (LSR). In this embodiment, the base plate (309) of the invention can be formed from a thermoplastic, such as cyclic block copolymer (CBC).

The compressible substrate (32) formed by a channel plate (5) and a base plate (6) form a compressible substrate (314). As shown in FIG. 22, in a preferred embodiment the channel plate (307) may be formed, at least in part from a compressible material, such a silicone or liquid silicone rubber (LSR). The channel plate (307) of the invention may include one or a plurality of first microfluidic channels (311) configured to receive a fluid sample, such as a blood or other biological sample. An adhesive membrane (308) can be positioned adjacent to the channel plate (307), and can further be formed from a pressure sensitive adhesive (PSA). As shown in FIG. 22, in a preferred embodiment the adhesive membrane (308) can include one or more second microfluidic channels (312) that can be in fluid communication with the first microfluidic channels (311) of the channel plate (307).

The base plate (309) of the invention can be positioned adjacent to the adhesive membrane (308) forming a compressible substrate (314) assembly that can be secured by a housing (4), formed preferably from a substantially non-compressible material. In this configuration, a fluid sample can be transmitted from an input position (302) to the first microfluidic channels (311) which can them transmit the fluid sample to the second microfluidic channels (312) of the adhesive membrane (308) forming an active area as described herein. As detailed elsewhere, a load force causes compression of the compressible substrate (314) causing the live cells of the biological sample within the active area (315) to diffuse thereby forming a cell monolayer. The active area (315) containing the cell monolayer can be positioned along the light pathway (24) of an imaging device (1), and preferably along a UV light pathway (24) of a microscope, camera or other imaging device known the art, and directly observed by a user.

As used herein, the term “comprise,” or variations thereof such as “comprises” or “comprising,” are to be read to indicate the inclusion of any recited integer (e.g., a feature, element, characteristic, property, method/process step or limitation) or group of integers (e.g., features, element, characteristics, properties, method/process steps or limitations) but not the exclusion of any other integer or group of integers. Thus, as used herein the term “comprising” is inclusive or open-ended and does not exclude additional, unrecited integers or method/process steps.

As used herein, the term “microfluidic chip” means a device for manipulating nanoliter to microliter volumes of liquid. Such devices frequently contain features such as channels, chambers, and/or valves, and can be fabricated from a variety of different materials, including, but not limited to, glass, or silicone. The terms “microfluidic chip” and “microfluidic mixing device,” “droplet microchip chip” and “chip” are used interchangeably.

A “channel,” as used herein, means a feature on or in an article (substrate) that at least partially directs the flow of a fluid. The channel can have any cross-sectional shape (circular, oval, triangular, irregular, square or rectangular, or the like) and can be covered or uncovered. In embodiments where it is completely covered, at least one portion of the channel can have a cross-section that is completely enclosed, or the entire channel may be completely enclosed along its entire length with the exception of its inlet(s) and outlet(s). A channel may also have an aspect ratio (length to average cross sectional dimension) of at least 2:1, more-typically at least 3:1, 5:1, or 10:1 or more. An open channel generally will include characteristics that facilitate control over fluid transport, e.g., structural characteristics (an elongated indentation) and/or physical or chemical characteristics (hydrophobicity vs. hydrophilicity) or other characteristics that can exert a force (e.g., a containing force) on a fluid. The fluid within the channel may partially or completely fill the channel. In some cases where an open channel is used, the fluid may be held within the channel, for example, using surface tension (i.e., a concave or convex meniscus).

The channel may be of any size, for example, having a largest dimension perpendicular to fluid flow of less than about 5 nun or 2 mm, or less than about 1 mm, or less than about 500 microns, less than about 200 microns, less than about 100 microns, less than about 60 microns, less than about 50 microns, less than about 40 microns, less than about 30 microns, less than about 25 microns, less than about 10 microns, less than about 3 microns, less than about 1 micron, less than about 300 nm, less than about 100 nm, less than about 30 nm, or less than about 10 nm. In some cases, the dimensions of the channel may be chosen such that fluid is able to freely flow through the article or substrate. The dimensions of the channel may also be chosen, for example, to allow a certain volumetric or linear flowrate of fluid in the channel. Of course, the number of channels and the shape of the channels can be varied by any method known to those of ordinary skill in the art. In some cases, more than one channel or capillary may be used. For example, two or more channels may be used, where they are positioned inside each other, positioned adjacent to each other, positioned to intersect with each other, etc.

As used herein, the term “biological sample” includes a sample from any bodily fluid or tissue. Biological samples or samples appropriate for use according to the methods provided herein include, without limitation, blood, serum, urine, saliva, CSF fluid, peritoneal fluid, tissues, cells, and organs, or portions thereof, as well as isolated cells derived from a subject, or other organism, such as a bacterium, plant, fungi or other cell. Additional embodiment can include bone marrow, such as bone marrow aspirates, as well as cell, tissues or fluid aspirates, including fine needles aspirates. A “subject” is any organism of interest, generally a mammalian subject, and preferably a human subject.

As used herein, “integral” means that portions of components are joined in such a way that they cannot be separated from each other without cutting or breaking the components from each other.

As used herein the singular forms “a”, “an”, and “the” include plural referents unless the context clearly dictates otherwise. Thus, for example, reference to “a compound” includes a plurality of such compounds, and reference to “the method” includes reference to one or more methods, method steps, and equivalents thereof known to those skilled in the art, and so forth. Similarly, the word “or” is intended to include “and” unless the context clearly indicates otherwise. Hence “comprising A or B” means including A, or B, or A and B. Furthermore, the use of the term “including”, as well as other related forms, such as “includes” and “included”, is not limiting.

The term “about” as used herein is a flexible word with a meaning similar to “approximately” or “nearly”. The term “about” indicates that exactitude is not claimed, but rather a contemplated variation. Thus, as used herein, the term “about” means within 1 or 2 standard deviations from the specifically recited value, or +a range of up to 20%, up to 15%, up to 10%, up to 5%, or up to 4%, 3%, 2%, or 1% compared to the specifically recited value.

1. A cell imaging system comprising:
a microfluidic device adapted to hold a biological sample within an active area of a compressible substrate;
a compression assembly configured to apply a compression force to said compressible substrate forming a cell monolayer within said active area;
a light source directed to said active area; and
wherein said device is configured to allow an imaging device to image or observe the cell monolayer within the active area while said compression force is applied to said compressible substrate.

2. The system of claim 1, wherein said biological sample comprises one or more live cells.

3. The system of claim 1, wherein said biological sample is selected from: blood, serum, urine, saliva, CSF fluid, peritoneal fluid, or a combination of the same, all of the foregoing optionally containing one or more live cells.

4. The system of claim 1, wherein said microfluidic device comprises a housing securing the compressible substrate.

5. The system of claim 4, wherein said compressible substrate comprises an adhesive membrane positioned between a channel plate positioned adjacent and base plate.

6. The system of claim 5, said channel plate comprises a first microfluidic channel in fluid communication with a second microfluidic channel on the adhesive membrane forming an active area.

7. The system of claim 6, wherein said housing comprises an input position and an output position in fluid communication with the first and second microfluidic channels.

8. The system of claim 5, wherein said microfluidic channels comprises hydrophilic inner surfaces.

9. The system of claim 5, wherein said channel plate comprises a liquid silicone rubber (LSR) channel plate or a silicone channel plate, said adhesive membrane comprises a pressure sensitive adhesive, and said base plate comprises a cyclic block copolymer (CBC).

10. The system of claim 4, wherein said housing is constructed substantially of a non-compressible material.

11. The system of claim 1, wherein said compression assembly comprises a spring-actuated compression assembly.

12. The system of claim 11, wherein said spring-actuated compression assembly comprises a bottom compression panel coupled with a top compression panel by one or more calibrated springs.

13. The system of claim 12, wherein a force applied to said top compression panel is transmitted to said bottom compression panel through said one or more calibrated spring

14. The system of claim 13, wherein said spring-actuated compression assembly comprises one or more cylinders, wherein each cylinder is responsive to a calibrated spring and secured by a lower and upper support post.

15. The system of claim 13, wherein said spring-actuated compression assembly can be calibrated to adjust the orientation or morphology of the cells in the monolayer.

16. (canceled)

17. The system of claim 1, wherein said light source is responsive to said compression assembly and positioned along light pathway.

18. The system of claim 17, wherein said light source is positioned within a compression cell that is responsive to said compression assembly and adapted to transmit a compression force to said microfluidic device.

19. The system of claim 17, wherein said compression cell comprises a guide adaptor positioned along the light pathway within a compression slot having a viewing surface adjacent to said active area on said microfluidic device.

20. The system of claim 1, further comprising an optical diffuser positioned between said light source and a viewing surface.

21. The system of claim 1, wherein said compression cell comprises an overhang surface configured to be positioned adjacent to the housing of said microfluidic device to prevent extended transit of the compression cell.

22-63. (canceled)
